(19) United States
(12) Patent Application Publication
(10) Pub. No.: US 2006/0154588 A1
(43) Pub. Date: Jul. 13, 2006

(54) Meat processing machine with fat analysis device

(76) Inventor: Dieter Evers, Straubenhardt (DE)

Correspondence Address: PERMAN & GREEN, 425 POST ROAD, FAIRFIELD, CT, 06824, US

(21) Appl. No.: 10/520,035

(22) PCT Filed: Jul. 2, 2003
(86) PCT No.: PCT/EP03/07045

§ 371 Date: Aug. 29, 2005

(30) Foreign Application Priority Data
Jul. 2, 2002 (DE) 102 29 694.4

(51) Int. Cl. A22B 5/00

(52) U.S. Cl. 452/198

(57) ABSTRACT

The invention relates to a meat processing machine, by means of which fresh or frozen meat is comminuted, filled, degassed and/or mixed and which includes a fat analysis device for determining the fat content in the meat.

The present invention relates to a meat processing machine with which fresh and/or frozen meat is comminuted, drawn off, degassed and/or mixed, characterised in that it comprises a fat analysis device for determining the fat content in the meat, and a temperature measurement means and a speed measurement means.

As meat products must not exceed a specific fat content nowadays, accurate fat analysis of meat and exact adjustment of specific fat contents in meat products are becoming increasingly important. The fat content of meat is currently often analysed discontinuously by removing a meat sample from a mixer or from a conveyor belt then analysing it in a laboratory. Fat is also sometimes analysed continuously, for example, by pumping a portion of the processed meat into a bypass where it is analysed. However, this procedure is acceptable only to a limited extent in the meat industry as the meat smears during this measurement and the bypass can only be inadequately cleaned. Furthermore, fat analysis of frozen meat is not possible, or is only possible to a limited extent, by this method.

The object is therefore to provide a device and a method for continuously determining the fat content of meat, which do not have the drawbacks of the prior art. A further object is to provide a means for determining the flow rate and a method for adjusting the fat content of a meat mixture.

The object is achieved according to the invention by a meat processing machine with which fresh and/or frozen meat is comminuted, drawn off, degassed and/or mixed and which comprises a fat analysis device for determining the fat content, a temperature measurement means and a speed measurement means. According to the invention the device additionally comprises means for measuring the temperature and the speed of the meat.

Preferably all measuring devices are integrated into the meat processing machine or are located in the immediate vicinity thereof.

A person skilled in the art has surprisingly found that it is possible to determine the instantaneous fat content and the instantaneous mass flow of the meat in the meat processing machine with comparatively low expenditure and that, according to a preferred embodiment, it is possible to integrate a fat analysis device into a meat processing machine or to locate it in the immediate vicinity thereof. The devices according to the invention have the advantage that meat processing and fat analysis take place in one device. There are clearly defined measuring conditions. The meat processing device according to the invention is simple and inexpensive to produce. Existing meat processing devices can be retrofitted with the three measuring devices. The instantaneous mass flow of meat through the meat processing device and the instantaneous fat content thereof are measured at least semi-continuously so that the average fat content of a resultant meat mixture can be determined and adjusted using this data.

A meat processing machine according to the invention is any meat processing machine known to a person skilled in the art with which meat is comminuted, mixed, degassed and/or drawn off. However, the meat processing machine is preferably a mixer, a filling machine or a comminuting machine, in particular a mincer.

Any fat analysis means familiar to a person skilled in the art can be considered as the fat analysis means. However, the fat analysis means preferably comprises a radiation source preferably with a plurality of energy stages and a radiation detector. In a particularly preferred embodiment the radiation source is an X-ray source and the radiation detector an X-ray detector. An infrared source is likewise preferred as the radiation source and an infrared detector as the radiation detector. It must be possible to measure the instantaneous fat content and the instantaneous basis weight in the measurement section using the fat analysis device.

With fat analysis by means of an X-ray detector, the weakening of the X-ray beam is preferably measured in an energy range between 18 and 40 keV. The thickness of the meat layer through which radiation has passed is preferably 50 to 80 mm, particularly preferably 65 to 75 mm. Preferably the fat content is calculated and the X-ray source controlled by a microprocessor or programmable controller.

Fat analysis can take place at any point of the meat processing machine in which the measurement section is, at least temporarily, not interrupted by moving parts, in particular metal parts.

The meat processing devices often comprise conveying units, for example conveying screws, and a comminuting unit, the conveying unit pressing the meat through the comminuting unit. Fat analysis then preferably takes place in the region of the conveying unit, care being taken in particular with this constellation that the measurement section is, at least temporarily, not interrupted by moving parts, in particular metal parts. Fat analysis can also preferably take place in the region between the conveying unit and comminuting unit. Fat analysis preferably also takes place in the region of comminution or in the region after comminution.

In a preferred embodiment the comminuting unit comprises at least a pre-cutter and/or at least a perforated disk. In this case measurement preferably takes place in the region of the pre-cutter and/or perforated disk. A perforated disk of this type or a pre-cutter of this type comprises recesses and the measurement section is then arranged, for example, in such a recess.

The meat processing device also comprises a temperature measurement means which is advantageously arranged in the vicinity of the fat analysis device. The temperature measurement means is preferably integrated into the fat analysis device. The state of aggregation of the meat to be processed can be ascertained inter alia using the temperature measurement means.

According to the invention the meat processing machine of the invention also comprises a speed measurement means so, in addition to the instantaneous fat content and the instantaneous temperature, the instantaneous speed of the meat can also be determined, measurement of the fat content and the flow rate not having to take place at the same point. The instantaneous flow rate of the meat is advantageously measured by an optical method of measurement and preferably after the processing, for example comminution, thereof. The optical method of measurement is preferably based on a light source, preferably a halogen lamp combined with a CCD camera.

The speed is particularly preferably measured in a discharge channel which is preferably arranged after processing of the meat, preferably its comminution by a perforated disk. This channel is at least partially open at the top so speed measurement takes place at least substantially at ambient pressure. The channel also comprises at least one window at which a means for preferably optically determining the flow rate of the meat in the discharge channel is arranged. The present invention therefore also relates to this discharge channel. The discharge channel has the advantage that the meat does not smear during speed measurement and that there is permanently a defined distance between the meat flowing past and the speed measurement means. The discharge channel can be directly connected to the meat processing device or integrated therein. The discharge channel is simple and inexpensive to produce and easy to clean.

In a preferred embodiment of the meat processing device according to the invention all measurements are taken continuously and evaluation is carried out every 1 to 2 seconds.

The present invention also relates to a method for determining the mean fat content of the meat in a mixture which meat is processed in the meat processing machine, the instantaneous fat content of the meat and its instantaneous mass flow being measured continuously and the mean fat content in a resultant meat mixture being calculated therefrom.

The instantaneous mass flow is preferably calculated by the following formula:
Fᵢ [g/s]=flᵢ [g/cm²] *b [cm] *vᵢ [cm/s]
wherein
Fᵢ denotes instantaneous mass flow
flᵢ denotes instantaneous basis weight in the measurement section
b denotes a correlation factor
vᵢ denotes instantaneous flow rate of the meat.

The correlation factor b is a function of the temperature of the meat to be processed and in a comminuting machine also depends on the method of comminution. The temperature of the meat to be processed is therefore preferably measured. This measurement is preferably taken in the vicinity of the point of the meat processing machine at which the instantaneous fat content of the meat is also measured.

The mean fat content of a resultant mixture is preferably determined by the formula:

$${Fe}_{av} = \frac{{\sum }_{l} \cdot {f}_{i} \cdot {F}_{i}}{\sum {F}_{i}}$$

wherein fᵢ is the instantaneous fat content.

This method has the advantage that, analysis of the mean fat content of the meat in a mixture does not lead to a time delay. No additional devices have to be provided for determining mean fat content of the meat. The fat content can be determined in both fresh and frozen meat. The consistency of the meat is not changed by the method according to the invention.

Fat analysis preferably takes place during comminution, mixing and/or drawing off, preferably using X-rays. Reference is made to the foregoing statements concerning this method of measurement.

The present invention also relates to a method for adjusting the fat content in a mixture using a meat processing machine wherein
the meat processing machine can be loaded with at least two streams having different fat contents
the actual fat content of the resultant mixture is determined continuously
a desired fat content is predetermined and
in the event of a difference between desired and actual fat content, the mixing ratio of the streams is changed.

The method according to the invention has the advantage that the mean fat content of a mixture can be purposefully adjusted or continuously changed without the production process having to be changed.

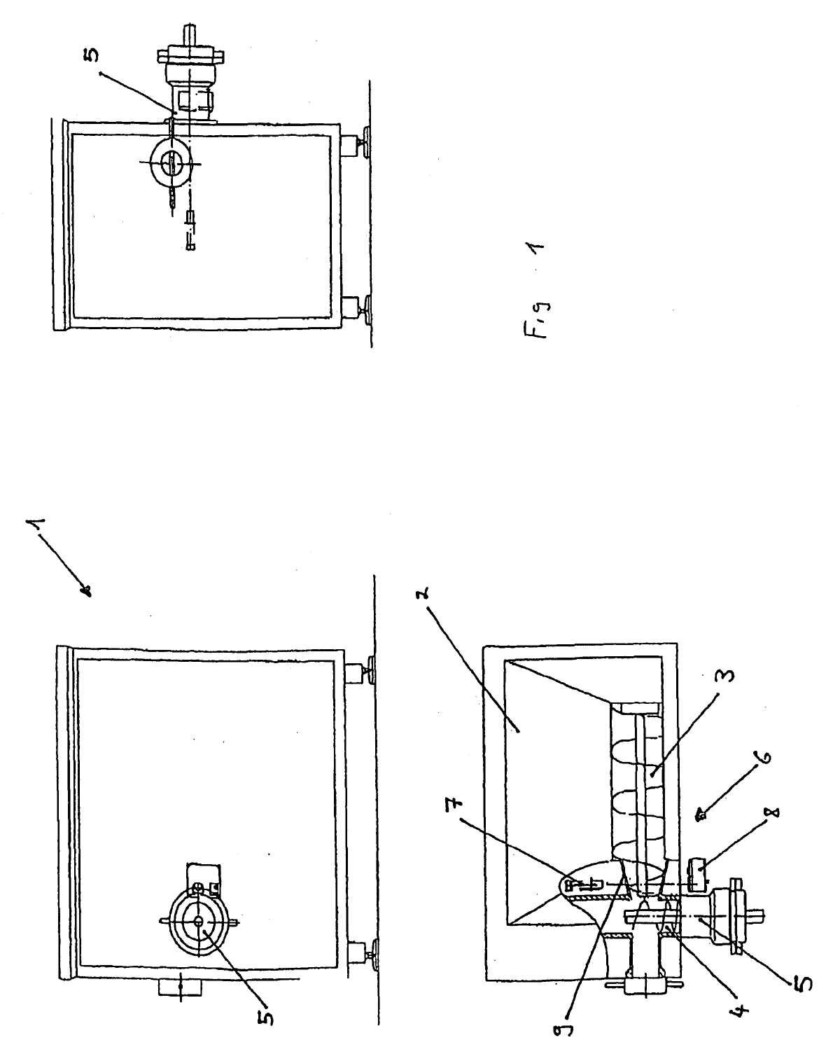

The invention will be described hereinafter with reference to FIGS. 1 to 9. These descriptions are merely exemplary and do not restrict the general idea of the invention.

FIG. 1 shows an angle mincer with a fat analysis device.

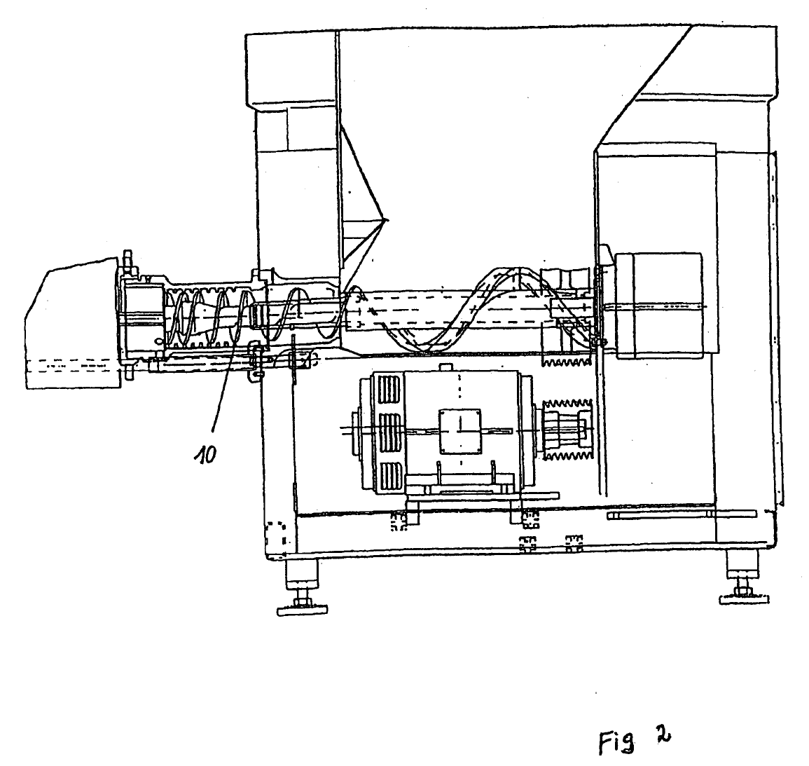

FIG. 2 shows a single-screw mincer.

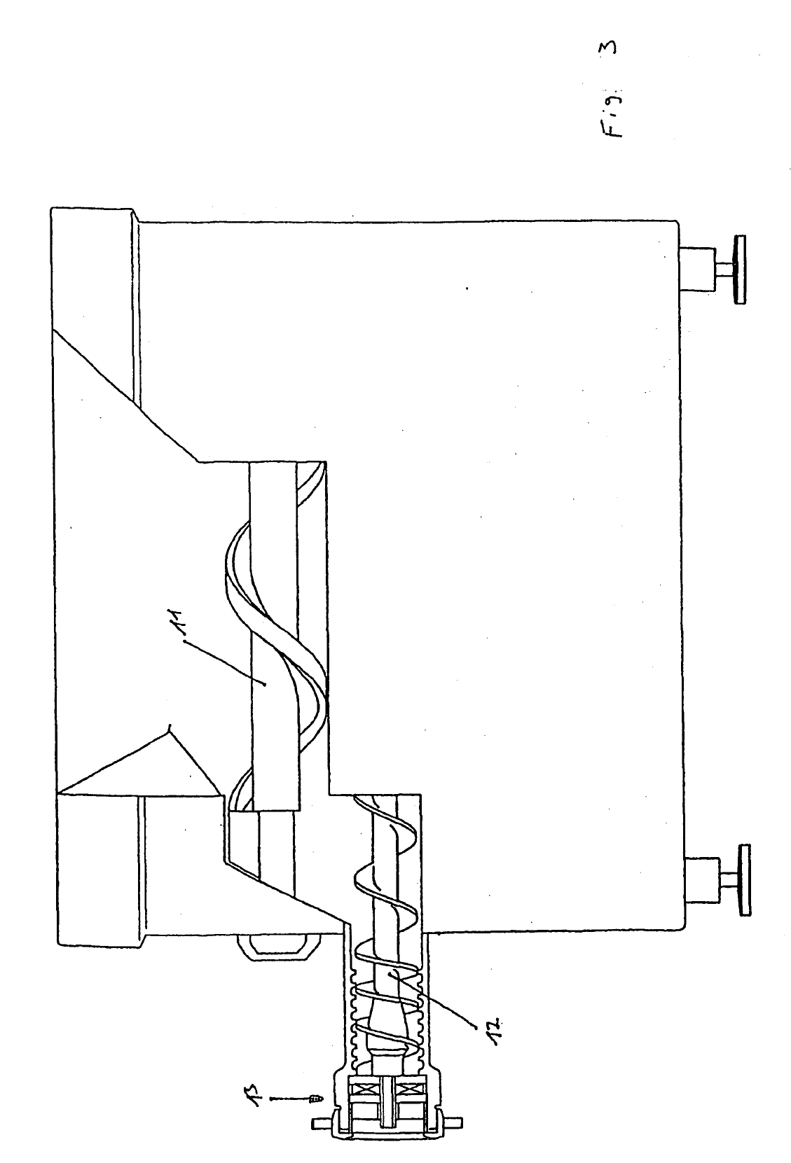

FIG. 3 shows a mincer with two offset screws.

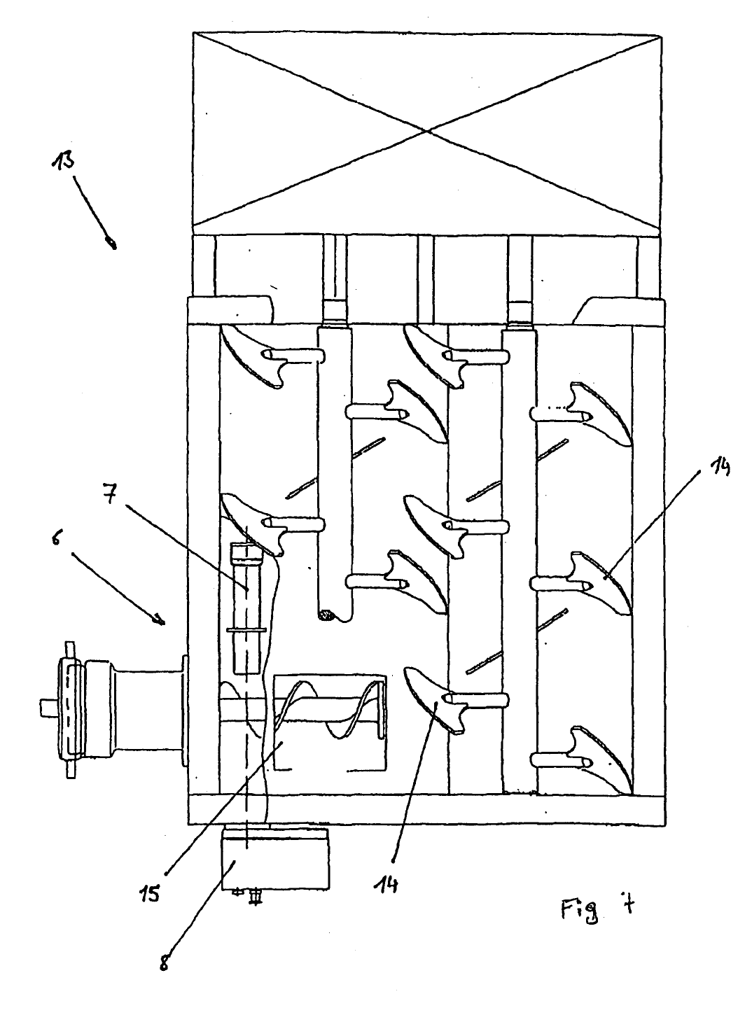

FIG. 4 shows a mixer with an attached comminuting device with a fat analysis device.

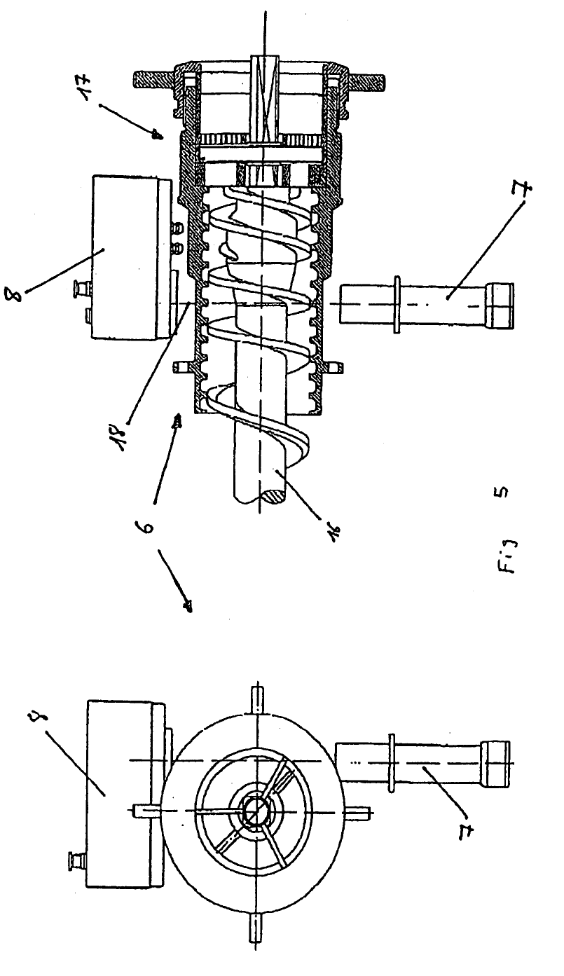

FIG. 5 shows a fat analysis device in the region of the conveying member.

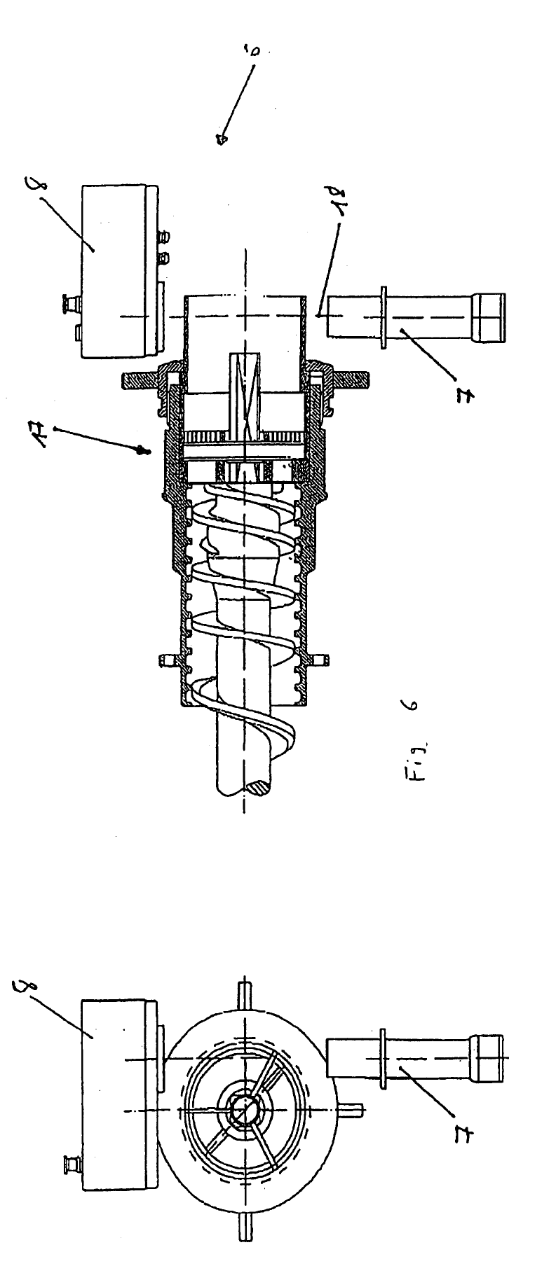

FIG. 6 shows a fat analysis device after the comminuting device.

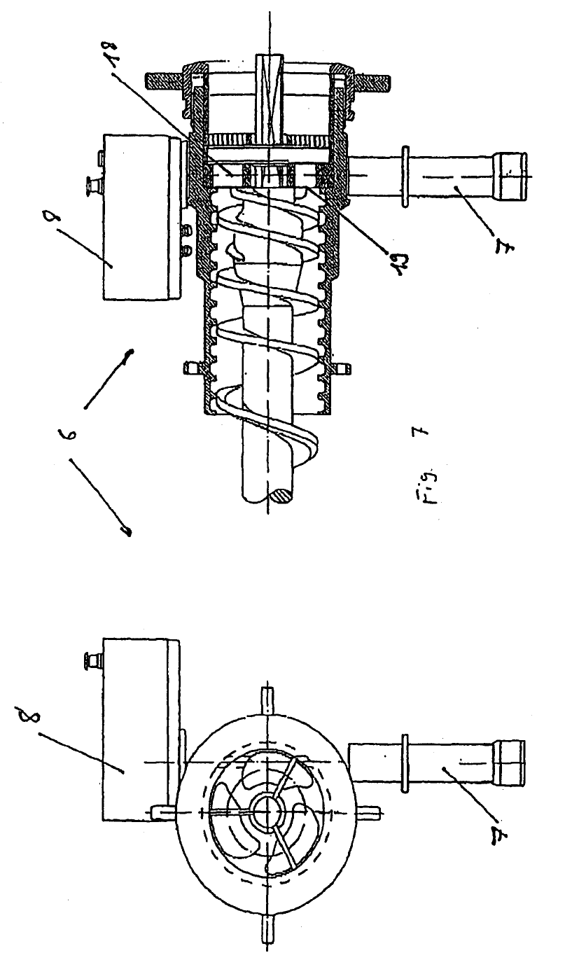

FIG. 7 shows a fat analysis device in the region of the comminuting device.

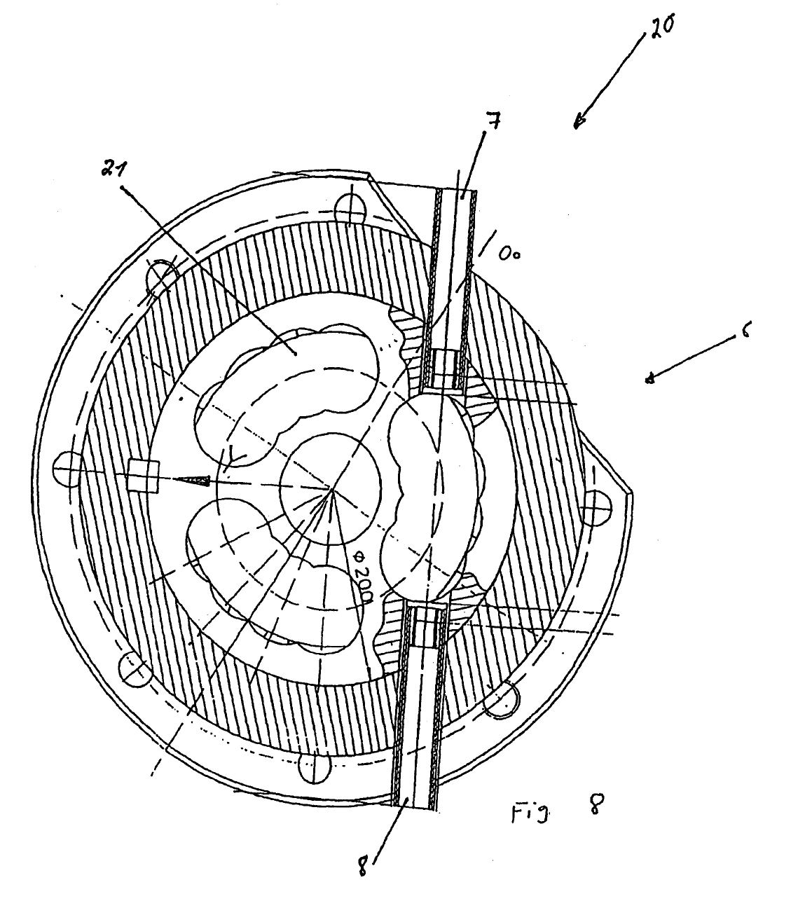

FIG. 8 shows a fat analysis device in the region of the pre-cutter.

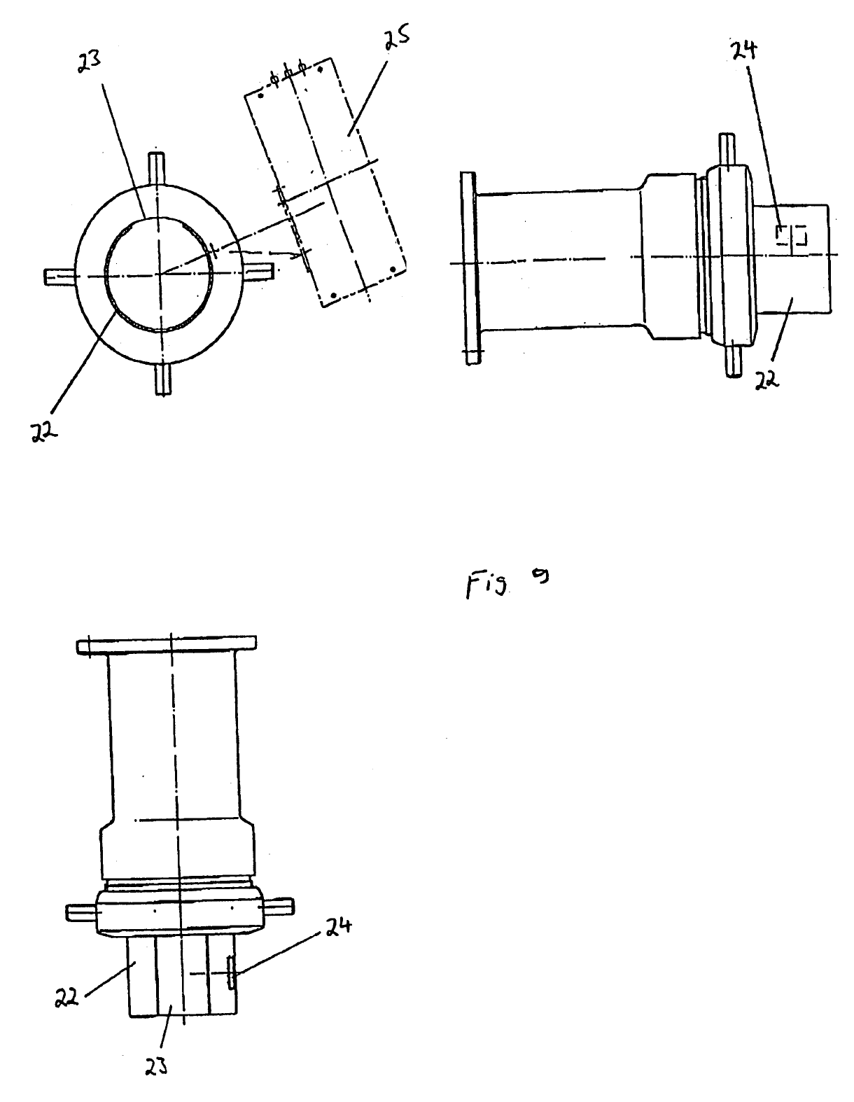

FIG. 9 shows the discharge channel according to the invention.

FIG. 1 shows an angle mincer 1 in three views. The fresh or frozen meat is poured into the funnel 2 and conveyed by the first and second screws 3, 4 to the cutting set 5 in which the meat is comminuted. The fat analysis device 6 is arranged in the region of the first screw 3 and consists of a radiation source 7 and a radiation detector 8. The fat analysis device is based in the present case on X-ray radiation. A person skilled in the art is aware that other measuring principles may also be used. A temperature measurement means (not shown) is located in the fat analysis region. With fat analysis devices in the region of moving parts it is important that the measurement section is not interrupted at the instant of measurement or, if the measurement section should be interrupted at the instant of measurement, that these measured values are rejected. The fat analysis device is arranged in the region of the first screw in such a way that it is ensured that all meat which is introduced into the mincer passes the fat analysis device. Constriction of the cross-section of the housing 9 of the screw 3 also ensures that the meat is already slightly compressed so the flow of meat only has a few gaps or no gaps. The instantaneous speed at which the meat is conveyed in the fat analysis region is ascertained by a speed measurement means (not shown), which is arranged at the outlet of the meat processing device, and the instantaneous mass flow of the meat is thus determined. In addition to the instantaneous fat content, the instantaneous basis weight in the measurement section is also determined by the fat analysis device, and the instantaneous meat mass flow is thus ascertained. A person skilled in the art is aware that the fat analysis device can also be arranged in the region of the screw 4, the cutting device 5, between the devices 4, 5 or after the device 5. The fat analysis device can also be arranged in the region of the funnel 2.

FIG. 2 shows a single-screw mincer. The screw 10 conveys the meat through a cutting set (not shown) in which the meat is comminuted. The fat analysis device and the temperature measurement means (neither of which are shown) can be arranged in the region of the screw 10 or thereafter, based on flow direction of the material. The measuring device is preferably part of the single-screw mincer. The fat analysis device and the temperature measurement means can also be arranged in the region of the filling funnel. The instantaneous speed at which the meat is conveyed is ascertained by a speed measurement means (not shown), which is arranged at the outlet of the meat processing device, and the instantaneous mass flow of the meat is thus determined. In addition to the instantaneous fat content, the instantaneous basis weight in the measurement section is also determined using the fat analysis device and the instantaneous meat mass flow is thus ascertained.

FIG. 3 shows a mincer with two offset screws 11, 12. The screws 11, 12 convey the meat through a cutting set 13 in which the meat is comminuted. The fat analysis device and the temperature measurement means (neither of which are shown) can be arranged in the region of the screws 11, 12 or thereafter, based on the flow direction of the material. The measuring device is preferably part of the single-screw mincer. The fat analysis device and the temperature measurement means can also be arranged in the region of the filling funnel. The instantaneous speed at which the meat is conveyed in the fat analysis region is ascertained by a speed measurement means (not shown), which is arranged at the outlet of the meat processing device, and the instantaneous mass flow of the meat is thus determined. In addition to the instantaneous fat content, the instantaneous basis weight in the measurement section is also determined using the fat analysis device and the instantaneous meat mass flow is thus ascertained.

FIG. 4 shows a mixer 13 with a large number of mixing members 14 and a discharge screw 15 with which the mixed meat is conveyed out of the mixer. A cutting device (not shown) can also be arranged downstream of the discharge screw. The fat analysis device 6 and the temperature measurement means (not shown) are arranged in the region of the screw 15. The fat analysis device 6 consists of a radiation source 7 and a radiation detector 8. The fat analysis device 6 is based in the present case on X-ray radiation. A person skilled in the art is aware that other measuring principles may also be used. With fat analysis devices in the region of the moving parts it is important that the measurement section is not interrupted at the instant of measurement, or if the measurement section should be interrupted at the instant of measurement that these measured values are rejected. The fat analysis device is arranged in the region of the screw in such a way that it is ensured that all meat which leaves the mixer passes the fat analysis device. The meat is already slightly compressed at the instant of measurement, so the flow of meat only has a few gaps or no gaps. The instantaneous speed at which the meat is conveyed in the fat analysis region is ascertained by a speed measurement means (not shown), which is arranged at the outlet of the meat processing device, and the instantaneous mass flow of meat is thus determined. The instantaneous basis weight of the meat is also determined by the fat analysis device, the weight being required for ascertaining the instantaneous meat mass flow. A person skilled in the art is aware that the fat analysis device can also be arranged in other regions of the mixer.

FIG. 5 shows a fat analysis device 6 and the temperature measurement means (not shown) in the region of the screw 16, for example the mincer. The screw 16 conveys the meat through a cutting set 17. The fat analysis device 6 consists of a radiation source 7 and a radiation detector 8. The measuring beam is illustrated by the broken line 18. The fat analysis device is based in the present case on X-ray radiation. A person skilled in the art is aware that other measuring principles can also be used. With fat analysis devices in the region of the moving parts it is important that the measurement section is not interrupted at the instant of measurement or, if the measurement section should be interrupted at the instant of measurement, that these measured values are rejected.

FIG. 6 shows a fat analysis device which is arranged downstream of the cutting device 17 according to FIG. 5. However, it is essential to the invention that the measuring device 6 is also part of the meat processing machine. Reference is also made to the statements relating to FIG. 5.

FIG. 7 shows a fat analysis device 6 in the region of the comminuting device 17. The comminuting device comprises inter alia a pre-cutter 19, in the region of which the measuring device is arranged. Reference is also made to the statements relating to FIGS. 5 and 6.

FIG. 8 shows a further fat analysis device in the region of a pre-cutter 20. The pre-cutter comprises three or more recesses 21 through which the meat is pressed. The fat analysis device 6 and a temperature measurement means (not shown) are arranged in one of these recesses. The fat analysis device 6 consists of a radiation source 7 and a radiation detector 8. In addition to the instantaneous fat content of the meat, the instantaneous basis weight thereof is also determined by the fat analysis device. In the present case, the measurement section is also interrupted by moving parts. This embodiment of the meat processing device according to the invention is particularly compact and very easy to produce.

FIG. 9 shows the discharge channel 22 according to the invention in three views, the channel being arranged at the outlet of the meat processing machine which in the present case is a mincer. A window 24, in front of which the speed measuring device 25 is provided, is arranged to the side on the discharge channel 22. The speed measurement means is based on a halogen lamp combined with a CCD camera. At the top, the discharge channel 22 has an opening 23 so the speed can be measured without pressure or substantially without pressure.

1. Meat processing device with which fresh and/or frozen meat is comminuted, drawn off, degassed and/or mixed, characterised in that it comprises a fat analysis device for determining the fat content, a temperature measurement means and a speed measurement means.

2. Meat processing device according to claim 1, characterised in that the temperature measurement means is arranged in the vicinity of the fat analysis device.

3. Meat processing device according to claim 1, characterised in that speed measurement takes place substantially without pressure after processing.

4. Meat processing device according to claim 1, characterised in that the speed is measured by an optical method.

5. Meat processing device according to claim 1, characterised in that the fat analysis device is based on measurement of X-ray radiation transmission.

6. Meat processing device according to claim 1, characterised in that it comprises at least a conveying unit and at least a comminuting unit, the conveying unit pressing the meat through the comminuting unit.

7. Meat processing device according to claim 6, characterised in that fat analysis takes place in the region of the comminuting unit.

8. Meat processing device according to claim 6, characterised in that the comminuting unit comprises at least a pre-cutter and/or a perforated disk.

9. Meat processing device according to claim 8, characterised in that the fat analysis means is arranged in the region of the pre-cutter and/or the perforated disk.

10. Meat processing device according to claim 9, characterised in that the fat analysis means is arranged in a recess of the pre-cutter and/or the perforated disk.

11. Means for determining the flow rate of comminuted meat, characterised in that it is a discharge channel which comprises a pressure-compensating opening and a window at which is arranged a preferably optical flow rate determining means.

12. Method for determining the average fat content of meat in a mixture which is processed in a meat processing machine, characterised in that the fat content of the meat and its mass flow are measured continuously and the mean fat content in a resultant meat mixture is calculated therefrom.

13. Method according to claim 12, characterised in that the instantaneous mass flow is calculated by the following formula
Fᵢ [g/s]=flᵢ [g/cm²] *b [cm] *vᵢ [cm/s]
wherein
Fᵢ denotes instantaneous mass flow
flᵢ denotes instantaneous basis weight in the measurement section
b denotes a correlation factor
vᵢ denotes instantaneous flow rate of the meat.

14. Method according to claim 13, characterised in that the mean fat content of a mixture is determined by the formula:
$${Fe}_{av} = \frac{{\sum }_{l} \cdot {f}_{i} \cdot {F}_{i}}{\sum {F}_{i}}$$
wherein f₁ is the instantaneous fat content.

15. Method for adjusting the fat content in a mixture using a meat processing machine according to claim 1, characterised in that
the meat processing machine can be loaded with at least two streams which have different fat contents,
the actual fat content of the resultant mixture is determined continuously,
a desired fat content is predetermined and
in the event of a difference between the desired and actual fat content, the mixing ratio of the streams is changed.
